(19) United States
(12) Patent Application Publication
(10) Pub. No.: US 2007/0233758 A1
(43) Pub. Date: Oct. 4, 2007

(54) METHOD OF HIGH-SPEED VIDEO MOTION DETECTION

(76) Inventor: DANIEL D MOSS, W Lafayette, IN (US)

Correspondence Address: DANIEL D. MOSS, 2208 INDIAN TRAIL DRIVE, W. LAFAYETTE, IN, 47906, US

(21) Appl. No.: 11/278,428

(22) Filed: Apr. 2, 2006

(51) Int. Cl. G06F 15/00

(52) U.S. Cl. 708/200

(57) ABSTRACT

An algorithm for the high-speed detection of temporal motion in a video signal by means of a digital high-pass filter which is applied to corresponding digital picture elements in sequential video frames. The resulting array of filtered values represents areas which are in motion within the video sequence, typically in the form of an outline of the objects that are in motion. This resulting array may subsequently be used for video bandwidth compression through the selective encoding of only the image areas which are in motion. The resulting array may also be used for the detection of coherent motion within the video signal through identification of the outline of the objects that are in motion.

### BACKGROUND

1. Field of Invention

This invention relates to a high-speed method of detecting motion within a video signal which may be used for various purposes including compressing the video signal bandwidth requirements and the detection of coherent motion within the video signal.

2. Description of Prior Art

A video signal is comprised of a sequence of individual, still images or “frames” that are displayed in rapid succession such that a viewer perceives that the images are “moving”. Each video image has a spatial dimension or width and height while a sequence of video images adds a temporal dimension. Thus, a video signal can be represented as a three-dimensional array with the Z-axis representing time. Notice that this time dimension is represented by discrete samples (video frames) rather than being a continuous representation in time. Typically, temporally adjacent video frames are very similar in visual content.

The spatial, digital compression of video images is well understood through the use of various techniques and image transforms, including the Discrete Cosign Transform (DCT) used by the JPEG and MPEG image compression standards.

Several well-known techniques have been used to temporally compress a video signal. One such technique, called “delta frame”, selects a base or “key” video frame and simply subtracts subsequent video frames from the key video frame. This technique has several limitations including that inconsequential background motion such as leaves blowing in the wind can cause the algorithm to fail.

Another well-known technique, called “motion compensation”, is used in the MPEG-2 video compression standard. Motion compensation divides a spatial video frame into blocks and then identifies which blocks have changed between a key video frame and the current frame. Finally, the motion compensation algorithm tries to identify the movement of the changed blocks within the video frame. The limitation of this technique is that it is very compute intensive, making it unsuitable for real-time video compression.

### SUMMARY

In accordance with the present invention comprises an algorithm for the high-speed detection of temporal motion in a video signal by means of a digital high-pass filter which is applied to corresponding digital picture elements in sequential video frames. The resulting array of filtered values represents areas which are in motion within the video sequence, typically in the form of an outline of the objects that are in motion. This resulting numerical array may subsequently be used for video bandwidth compression through the selective encoding of only the image areas which are in motion. The resulting array may also be used for the detection of coherent motion within the video signal through identification of the outline of the objects that are in motion.

### OBJECTS AND ADVANTAGES

Accordingly, besides the objects and advantages of a high-speed video motion detection algorithm described above, several objects and advantages of the present invention are:
a. to provide a method of detecting spatial areas of motion within a video signal without prior knowledge of the video sequence,
b. to provide a method of video bandwidth compression in which only the areas of spatial motion are compressed,
c. to provide a method of motion detection that discriminates between coherent motion and random motion within a video signal and
d. to provide a high-speed method of motion detection that does not require spatial image correlation.

### DESCRIPTION OF DRAWINGS

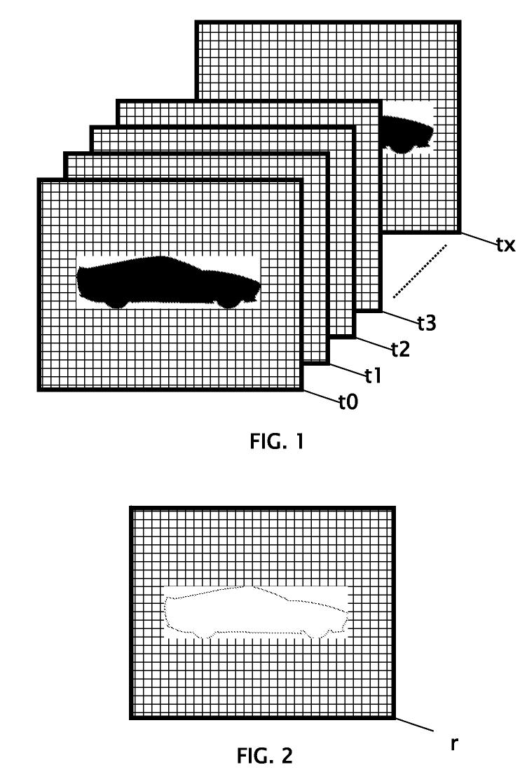

The drawing FIG. 1 shows a sequence of video frames, labeled t0, t1, t2, t3 . . . tx, continuing indefinitely in time. Each video frame can be represented as a two-dimensional array of individual, digital picture elements (“pixels”). This example shows an image of a car which is moving in time such that the car's image is displaced slightly between the sequential, video frames while the stationary or background areas of the video sequence remain unchanged.

The drawing FIG. 2 shows the resulting pixel array r in which the pixels that have changed in time have been isolated by the algorithm. The object(s) in motion within the video sequence appear as an outline, in this example the outline of a car. As an object moves in time, the pixels on the edge of the object are spatially displaced revealing the stationary background behind the moving object.

### PREFERRED EMBODIMENT

A preferred embodiment of the motion detection algorithm uses a digital, high-pass filter that is applied on a pixel-by-pixel basis to video frames t0, t1, t2, and t3 where each video frame is represented by an array of (x,y) pixel values (FIG. 1). The resulting, high-pass filter value is placed in the result array r (FIG. 2). The following pseudo-code represents the process, where H0, H1, H2, and H3 are the high-pass filter constant values of a well-known, high-pass filter equation.

for (y=0; y < height; y++) {

for (x=0; x < width; x++) {

r(x,y) = H3 * t0(x,y) − H2 * t1(x,y) + H1 * t2(x,y) − H0 *
t3(x,y);

}

}

This process continues in time. For example, in the next iteration the above routine uses video frames t2, t3, t4, and t5.

The result array r may be used for different purposes, including but not limited to:

a) video bandwidth compression and

b) detecting and identifying coherent motion within the video signal.

Video bandwidth compression is accomplished by applying a threshold value to the result array r such that result array values that are above the threshold have changed in time so that the corresponding pixel value from video frame t0 is selected for encoding while result array values that are below the threshold value have not changed in time and are not encoded and the pixel value from a previous video key frame is retained by the video receiver-decoder. Typically, there is a great deal of similarity between sequential video frames so that encoding only the pixels that have changed in time yields very high video compression rates. In the event of an abrupt change in the video scene, the compression algorithm will spatially encode a single video key frame. An abrupt change is detected by the compression algorithm through a count of the number of pixels that have changed in the result array.

The result array r typically contains the outlines of the objects within the video sequence that are in motion. For example, if there is no motion within the video frames then the result array would contain all zero values. Random motion or noise that appears within only a single frame of the video sequence is similarly rejected by the high-pass filter. Simple, solid objects that are in motion appear in the result array as the outline of the solid object. Complex objects, such as a human face that are in motion appear as both the outline of the overall object as well as the outlines of the details within the object. In the example of a human face, the outlines of the eyes, nose, mouth, etc. will appear within the outline of the head in the result array.

Coherent motion may be automatically separated from random motion through the isolation of contiguous outlines within the result array. Random motion will appear as disjoint points or small areas within the result array while coherent motion can be identified through an outline which defines a minimum spatial area. There are several, well-known methods for the isolation of a contiguous shape outline. It is also possible to apply a shape identification algorithm to the isolated outline in order to automatically differentiate a person from a car or from an animal for example.

### CONCLUSION, RAMIFICATIONS AND SCOPE OF INVENTION

Thus the reader will see that the algorithm of the invention provides a high-speed method of isolating the areas of motion in a video sequence that can be used in a variety of applications including but not limited to video bandwidth compression and the detection of coherent motion within a video sequence. The digital high-pass filter algorithm does not require any prior knowledge of the video sequence and the algorithm can be executed at high-speed.

I claim:

1. A method of detecting motion in a video sequence, comprising:
a. providing a memory which is able to store a series of sequential video images as a two-dimensional array of digital picture elements,
b. providing a memory which is able to store the result of the process as a two-dimensional array of digital values,
c. providing a digital, high-pass filter,
d. providing a means of control which will apply the said high-pass filter to digital picture elements in the said video image memory to produce a resulting value which is entered into the said result memory,
whereby said result memory will contain values which represent motion in the said sequence of video images.

2. A method of compressing digital video signals by means of comparing the result data values of claim 1 to a predetermined value in order to selectively encode the digital video data values that have changed in time.

3. A method of detecting coherent motion by means of comparing the result data values of claim 1 to a predetermined value in order to detect the outline of moving objects within the video signal.
